(19) United States
(12) Patent Application Publication
(10) Pub. No.: US 2026/0233689 A1
(43) Pub. Date: Aug. 13, 2026

(54) WIRE FIXING MEMBER

(71) Applicant: SUMITOMO WIRING SYSTEMS, LTD., Yokkaichi-shi , Mie (JP)

(72) Inventor: Naoto TSUKIMORI, Yokkaichi-shi (JP)

(73) Assignee: SUMITOMO WIRING SYSTEMS, LTD., Yokkaichi-shi , Mie (JP)

(21) Appl. No.: 19/156,048

(22) PCT Filed: Feb. 7, 2024
(86) PCT No.: PCT/JP2024/004115

§ 371 Date: Aug. 13, 2025

(30) Foreign Application Priority Data
Feb. 22, 2023 (JP) 2023-026015

(51) Int. Cl. B60R 16/02; H02G 3/30

(52) U.S. Cl. CPC B60R 16/0215; H02G 3/30

(57) ABSTRACT

A wire fixing member that is configured to fix a wire harness laid out below an attachment object to the attachment object, the wire fixing member including: a support having: a plate-shaped support plate that is configured to extend along an extension direction of the wire harness and capable of supporting the wire harness from below; and fixing portions provided at a plurality of locations along the extension direction on the support plate, extending upward from the support plate, and capable of being fixed to the attachment object.

### BACKGROUND

The present disclosure relates to a wire fixing member.

For example, some conventional wire fixing member includes a clip that holds a portion, in the extension direction, of a wire harness, and this clip is fastened to an attachment object with a bolt (e.g., see JP H11-210934A). When, for example, a wire harness is fixed that is to be laid out below an attachment object such as an under-floor panel of a vehicle, the wire harness can be fixed to the attachment object, for example, by providing clips at a plurality of locations along the extension direction on the wire harness.

### SUMMARY

However, the wire fixing member such as the above has a problem that when the wire harness is flexible, the wire harness will hang down between the clips. Note that using many clips can suppress hanging down of the wire harness, but in this case, the number of components and the number of assembly steps will increase.

An exemplary aspect of the disclosure provides a wire fixing member capable of preventing a wire harness from hanging down with a simple configuration.

A wire fixing member of the present disclosure is a wire fixing member that fixes a wire harness laid out below an attachment object to the attachment object, the wire fixing member including: a support member having: a plate-shaped support plate portion extending along an extension direction of the wire harness and capable of supporting the wire harness from below; and fixing portions provided at a plurality of locations along the extension direction on the support plate portion, extending upward from the support plate portion, and capable of being fixed to the attachment object.

According to the wire fixing member of the present disclosure, it is possible to prevent the wire harness from hanging down with a simple configuration.

### BRIEF DESCRIPTION OF THE DRAWINGS

FIG. 1 is a diagram showing a schematic configuration of a wire harness and a wire fixing member according to an embodiment.

FIG. 2 is a schematic side view of the wire harness and the wire fixing member according to the embodiment.

FIG. 3 is a cross-sectional view taken along line 3-3 in FIG. 2.

FIG. 4 is a cross-sectional view of the wire harness and the wire fixing member in another example.

### DETAILED DESCRIPTION OF EMBODIMENTS

### Description of Embodiments of Present Disclosure

First, modes for carrying out the present disclosure are listed and described.

[1] A wire fixing member of the present disclosure is a wire fixing member that fixes a wire harness laid out below an attachment object to the attachment object, the wire fixing member including: a support member having: a plate-shaped support plate portion extending along an extension direction of the wire harness and capable of supporting the wire harness from below; and fixing portions provided at a plurality of locations along the extension direction on the support plate portion, extending upward from the support plate portion, and capable of being fixed to the attachment object.

According to this configuration, the support member included in the wire fixing member has the plate-shaped support plate portion extending along the extension direction of the wire harness, and the fixing portions provided at a plurality of locations along the extension direction on the support plate portion and extending upward from the support plate portion. The fixing portions are fixed to the attachment object, and the wire harness is supported by the support plate portion. Thus, the wire harness can be prevented from hanging down with a simple configuration.

[2] The wire fixing member may further include a holding-fixing member configured to hold a portion, in the extension direction, of the wire harness, the holding-fixing member being fixed to the support plate portion.

According to this configuration, the holding-fixing member is provided that holds a portion, in the extension direction, of the wire harness and is fixed to the support plate portion, thereby preventing the wire harness from detaching from the support plate portion.

[3] The fixing portions may include: a first fixing portion extending upward from a first end, in a width direction, of the support plate portion; and a second fixing portion extending upward from a second end, in the width direction, of the support plate portion, and the first fixing portion and the second fixing portion may be provided alternately in the extension direction on the support plate portion.

According to this configuration, the first fixing portion extending upward from the first end, in the width direction, of the support plate portion and the second fixing portion extending upward from the second end, in the width direction, of the support plate portion are provided alternately in the extension direction of the support plate portion. This stabilizes the orientation of the support plate portion. That is, for example, in a configuration in which the fixing portions are provided only at the first end, in the width direction, of the support plate portion, there is concern that the support plate portion will bend and incline downward on the second end side. However, the bending of the support plate portion can be suppressed. Thus, the wire harness can be stably prevented from hanging down.

[4] The fixing portions may be provided only at one end, in a width direction, of the support plate portion.

According to this configuration, the fixing portions are provided only at one end, in the width direction, of the support plate portion. This allows for an arrangement in a small arrangement space, for example. That is, for example, in a configuration in which the fixing portions are provided at both ends, in the width direction, of the support plate portion, a fixing space may be required at both ends, in the width direction, of the support plate portion. However, this can be avoided.

[5] In any of [1] to [4] above, the support member may have a side wall portion extending upward from an end, in a width direction, of the support plate portion.

According to this configuration, the support member has the side wall portion extending upward from an end, in the width direction, of the support plate portion, thereby suppressing detachment of the wire harness from the support plate portion.

[6] The fixing portions may be provided only at a first end, in the width direction, of the support plate portion, and the side wall portion may be provided only at a second end, in the width direction, of the support plate portion.

According to this configuration, the fixing portions are provided only at the first end, in the width direction, of the support plate portion. This allows for an arrangement in a small arrangement space, for example. Further, the side wall portion is provided only at the second end, in the width direction, of the support plate portion, thereby suppressing detachment of the wire harness from the second end of the support plate portion. Note that detachment of the wire harness from the first end of the support plate portion is suppressed by the fixing portions extending upward from the support plate portion.

### Details of Embodiments of the Present Disclosure

Specific examples of a wire fixing member of the present disclosure are described below with reference to the drawings. The drawings may partially exaggerate or simplify some components for convenience of description. The dimensional ratio of each part may differ between the drawings. The terms “parallel”, “orthogonal”, and “perfect circle” herein include not only cases of being strictly parallel, orthogonal, or a perfect circle but also cases of being substantially parallel, orthogonal, or a perfect circle in the range that exhibits the operation and effect of the present embodiment. Note that the present disclosure is not limited to these examples but is defined by the claims, and is intended to include all modifications made within the meaning and scope equivalent to the claims.

### (Overall Configuration of Wire Harness 10)

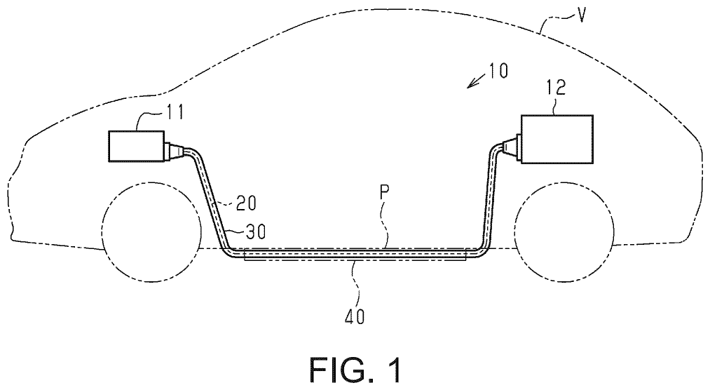

A wire harness 10 shown in FIG. 1 electrically connects two or three or more electrical devices to each other. For example, the wire harness 10 electrically connects an inverter 11 installed in a front part of a vehicle V, such as a hybrid vehicle or an electric vehicle, and a high-voltage battery 12 installed rearward of the inverter 11 in the vehicle V, to each other. For example, the wire harness 10 is laid out to pass under the floor or the like of the vehicle V. For example, an intermediate portion, in the lengthwise direction, of the wire harness 10 is laid out so as to pass outside the vehicle interior below an under-floor panel P, which serves as an attachment object, in the vehicle V.

The inverter 11 is connected to a motor for driving wheels (not shown) that serves as a power source for the vehicle to travel. The inverter 11 generates AC power from DC power from the high-voltage battery 12, and supplies the AC power to the motor. The high voltage battery 12 is, for example, a battery capable of supplying a voltage of several hundred volts.

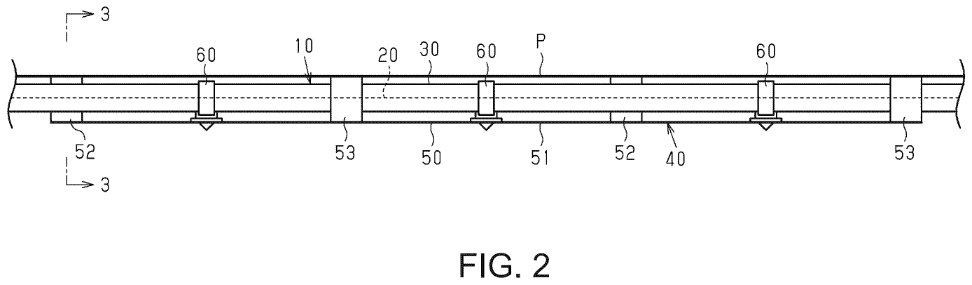

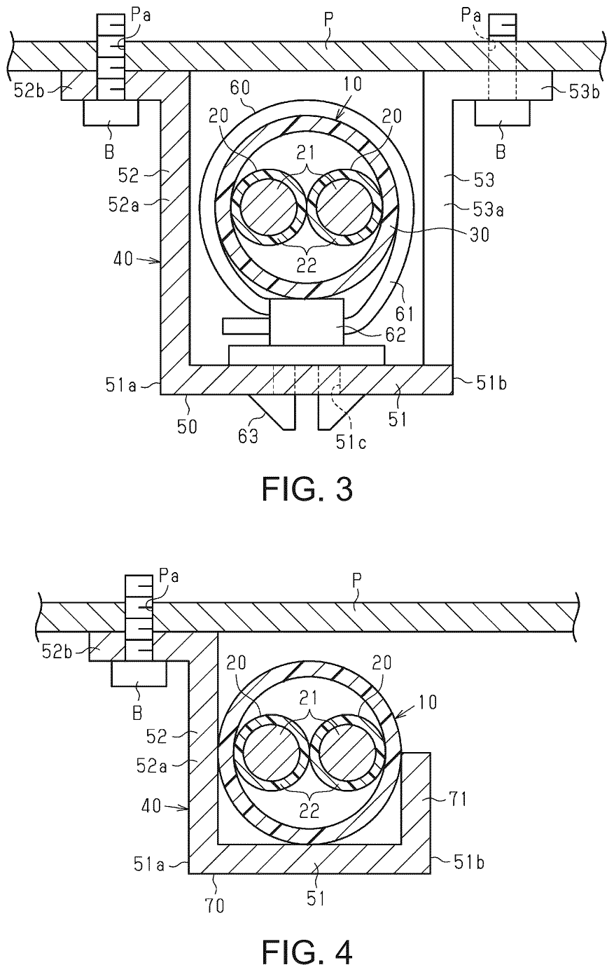

As shown in FIGS. 2 and 3, the wire harness 10 includes a plurality of electric wires 20 electrically connecting the above-described electrical devices to each other, and a corrugated tube 30 serving as an exterior member covering the outer periphery of the electric wires 20.

### (Configuration of Electric Wire 20)

As shown in FIG. 3, the wire harness 10 of the present embodiment includes two electric wires 20. Each electric wire 20 has a core wire 21 and an insulating coating 22 that covers the outer periphery of the core wire 21.

The core wire 21 is constituted by a stranded wire that includes a plurality of conductive strands twisted together, or by a single core wire or the like. The core wire 21 is made of, for example, a copper-or aluminum-based metal material.

The insulating coating 22 covers the outer peripheral surface of the core wire 21 over the entire circumference, for example. The insulating coating 22 is made of, for example, an insulating material such as a synthetic resin composed mainly of a polyolefin resin such as cross-linked polyethylene or cross-linked polypropylene.

### (Configuration of Corrugated Tube 30)

The corrugated tube 30 has a cylindrical shape. The corrugated tube 30 has a bellows structure in which a large-diameter portion and a small-diameter portion having diameter smaller than that of the large diameter portion are alternately provided in the lengthwise direction of the corrugated tube 30. Note that the bellows structure is omitted and the corrugated tube 30 is schematically shown in the figure. The corrugated tube 30 is flexible and easily bendable due to the bellows structure. For example, a synthetic resins such as polyolefin, polyamide, polyester, or ABS resin can be used as a material of the corrugated tube 30. The corrugated tube 30 collectively covers the two electric wires 20 to protect them.

### (Configuration of Wire Fixing Member 40)

As shown in FIGS. 2 and 3, the wire fixing member 40 fixes the wire harness 10, which is laid out below the under-floor panel P, to the under-floor panel P. The wire fixing member 40 includes a support member 50 (support) and band clips 60 that serve as holding-fixing members.

### (Configuration of Support Member 50)

The support member 50 has a support plate portion 51 (support plate), and first fixing portions 52 and second fixing portions 53 that serve as fixing portions. The support member 50 is made of a metal material. The support plate portion 51 has a plate shape extending along the extension direction of the wire harness 10 and capable of supporting the wire harness 10 from below.

The first fixing portions 52 and the second fixing portions 53 are provided at a plurality of locations along the extension direction on the support plate portion 51, extend upward from the support plate portion 51, and can be fixed to the under-floor panel P. Specifically, the first fixing portions 52 extend upward from a first end 51a, in the width direction, of the support plate portion 51. Each first fixing portion 52 has a first upward extending portion 52a that extends upward from the first end 51a, and a first fixing piece 52b that extends outward in the width direction from an upper end of the first upward extending portion 52a. The second fixing portions 53 extend upward from a second end 51b, in the width direction, of the support plate portion 51. Each second fixing portion 53 has a second upward extending portion 53a that extends upward from the second end 51b, and a second fixing piece 53b that extends outward in the width direction from an upper end of the second upward extending portion 53a. Note that the width direction of the support plate portion 51 is a direction intersecting the extension direction of the support plate portion 51, and coincides with the left-right direction in FIG. 3. Each first fixing portion 52 is fixed to the under-floor panel P by a bolt B, which passes through the first fixing piece 52b and is threaded into a female threaded hole Pa formed in the under-floor panel P. Each second fixing portion 53 is fixed to the under-floor panel P by a bolt B, which passes through the second fixing piece 53b and is threaded into a female threaded hole Pa formed in the under-floor panel P.

As shown in FIG. 2, the first fixing portions 52 and the second fixing portions 53 are separated from each other in the extension direction of the support plate portion 51 and are provided alternately. In the present embodiment, the first fixing portions 52 and the second fixing portions 53 constitute a total of four fixing portions, which are arranged at equal intervals at both ends, in the extension direction, of the support plate portion 51 and between the two ends.

### (Configuration of Band Clip 60)

Each band clip 60 holds a portion, in the extension direction, of the wire harness 10 and is fixed to the support plate portion 51. Each band clip 60 has a flexible and soft band-shaped portion 61, a lock portion 62 provided at an end, in the lengthwise direction, of the band-shaped portion 61, and an engaging portion 63 provided at the lock portion 62. The lock portion 62 locks the band-shaped portion 61 by restricting, with the band-shaped portion 61 passing through the lock portion 62, movement of the band-shaped portion 61 in a direction in which the band-shaped portion 61 is pulled out that is opposite to the direction in which the band-shaped portion 61 passes through the lock portion 62. The band-shaped portion 61 is passed through the lock portion 62 so as to cover the entirety of the wire harness 10, more specifically the corrugated tube 30, in the circumferential direction, thereby allowing the band clip 60 to hold a portion, in the extension direction, of the wire harness 10. The band clip 60 is then fixed to the support plate portion 51 by fitting the engaging portion 63 into an engagement hole 51c provided in the support plate portion 51.

Each band clip 60 is arranged between one first fixing portion 52 and one second fixing portion 53 in the extension direction of the support plate portion 51. That is, three band clips 60 are provided, each of which is located between two out of a total of four fixing portions, which are the first fixing portions 52 and the second fixing portions 53. Note that FIG. 2 schematically shows the wire harness 10 in a linear shape, but depending on the degree of slack or the like, the wire harness 10 is supported in partial contact with the support plate portion 51, for example.

Next, the operation of the wire fixing member 40 having the above configuration is described.

The wire harness 10 is fixed to the under-floor panel P by the wire fixing member 40. The support plate portion 51 extending along the extension direction of the wire harness 10 supports the wire harness 10 from below, thereby preventing a portion, in the extension direction, of the wire harness 10 from hanging downward of the support plate portion 51. Further, the support plate portion 51 covers the ground side of the wire harness 10 and thus protects it from collisions with foreign objects from the ground side, for example.

Next, the effect of the above embodiment is described below.

(1) The support member 50 included in the wire fixing member 40 has the plate-shaped support plate portion 51 extending along the extension direction of the wire harness 10, and the first fixing portion 52 and the second fixing portion 53 that are provided at a plurality of locations along the extension direction on the support plate portion 51 and extend upward from the support plate portion 51. The first fixing portion 52 and the second fixing portion 53 are fixed to the under-floor panel P, and the wire harness 10 is supported by the support plate portion 51. Thus, the wire harness 10 can be prevented from hanging down with a simple configuration.

(2) The wire fixing member 40 includes the band clip 60 that holds a portion, in the extension direction, of the wire harness 10 and is fixed to the support plate portion 51, thereby preventing the wire harness 10 from detaching from the support plate portion 51.

(3) The first fixing portion 52 extending upward from the first end 51a, in the width direction, of the support plate portion 51 and the second fixing portion 53 extending upward from the second end 51b, in the width direction, of the support plate portion 51 are provided alternately in the extension direction of the support plate portion 51. Thus, the orientation of the support plate portion 51 is stabilized. That is, for example, in a configuration in which the fixing portion is provided only at the first end 51a, in the width direction, of the support plate portion 51, there is concern that the support plate portion 51 will bend and incline downward on the second end 51b side. However, the bending of the support plate portion 51 can be suppressed. Thus, the wire harness 10 can be stably prevented from hanging down.

The present embodiment can be modified as follows when implemented. The above embodiment and the following modifications can be implemented in combination as long as no technical contradiction arises. -In the above embodiment, the support member 50 has the first fixing portion 52 and the second fixing portion 53 each of which serves as the fixing portion. However, there is no limitation thereto, and, for example, either the first fixing portion 52 or the second fixing portion 53 may be omitted. That is, the support member 50 may be provided only at one end, in the width direction, of the support plate portion 51.

For example, a support member 70 may only have the first fixing portion 52 serving as the fixing portion as shown in FIG. 4. This allows for an arrangement in a small arrangement space, for example. That is, for example, in a configuration in which the fixing portions are provided at both ends, in the width direction, of the support plate portion 51, a fixing space is required at both ends, in the width direction, of the support plate portion 51. However, this can be avoided.
In the above embodiment, the wire fixing member 40 includes the band clip 60 that holds a portion, in the extension direction, of the wire harness 10 and is fixed to the support plate portion 51. However, there is no limitation thereto, and a configuration without the band clip 60 may be employed.

For example, a modification may be made as shown in FIG. 4. In this example, the wire harness 10 is supported while the entirety thereof in the extension direction is in contact with the support plate portion 51.
Each of the support member 50 and the support member 70 in the above embodiment may have a side wall portion extending upward from an end, in the width direction, of the support plate portion 51.

For example, as shown in FIG. 4, the support member 70 may have only the first fixing portion 52, and a side wall portion 71 (side wall) may be provided only at the second end 51b, in the width direction, of the support plate portion 51. With this configuration, the support member 70 has the side wall portion 71 extending upward from an end, in the width direction, of the support plate portion 51, thereby suppressing detachment of the wire harness 10 from the support plate portion 51. In this example, the fixing portion is the first fixing portion 52 that is provided only at the first end 51a, in the width direction, of the support plate portion 51, and the second fixing portion 53 is not provided. This allows for an arrangement in a small arrangement space, for example. Further, the side wall portion 71 is provided only at the second end 51b, in the width direction, of the support plate portion 51, thereby suppressing detachment of the wire harness 10 from the second end 51b of the support plate portion 51. Note that detachment of the wire harness 10 from the first end 51a of the support plate portion 51 is suppressed by the first fixing portion 52 extending upward from the support plate portion 51. The side wall portion 71 may be provided over the entire support plate portion 51 in the extending direction, or may be provided partially. Further, the side wall portion 71 may alternatively be provided at the first end 51a.
In the above embodiment, the wire fixing member 40 includes only one support member 50. However, there is no limitation thereto, and the wire fixing member 40 may include two or more support members 50 in the extension direction of the wire harness 10.
In the above embodiment, the bolts B for fixing the first fixing portion 52 and the second fixing portion 53 are threaded into the female threaded holes Pa formed in the under-floor panel P. However, there is no limitation thereto, and, for example, the bolts B may alternatively be threaded into nuts disposed above the under-floor panel P.
In the above embodiment, the first fixing portion 52 and the second fixing portion 53 respectively have the first fixing piece 52b and the second fixing piece 53b that are fixed by the bolts B. However, there is no limitation thereto, and the first fixing portion 52 and the second fixing portion 53 may be fixed to the under-floor panel P with any other configuration.
In the above embodiment, the attachment object is the under-floor panel P of the vehicle V. However, there is no limitation thereto, and the attachment object may be another object below which the wire harness 10 is laid out, instead of the under-floor panel P.
In the above embodiment, the wire harness 10 includes the corrugated tube 30. However, there is no limitation thereto, and a configuration without the corrugated tube 30 may be employed. Further, the corrugated tube 30 may be changed to any other exterior member such as a flexible hose.
In the above embodiment, the wire harness 10 has two electric wires 20. However, there is no limitation thereto, and the wire harness 10 may have only one electric wire 20 or three or more electric wires 20.
The wire harness 10 in the above embodiment may also have an electromagnetic shield member that covers the outer periphery of the electric wires 20 and is covered by the corrugated tube 30. The electromagnetic shield member may be, for example, a braided wire obtained by braiding conductive elemental wires in a tubular shape.
In the non-limiting embodiments shown in FIGS. 3 and 4, the support plate portion 51 of the support member 50 may have a length corresponding to a predetermined length portion of the wire harness 10 excluding both ends. The support plate portion 51 can be configured to restrict the wire harness 10 from warping downward in the gravity direction over the length of the support member 50, is referred to as a bottom plate in some cases, and may have, for example, a flat plate. The upper surface of the support plate portion 51 of the support member 50 is in some cases referred to as a bottom surface that supports the wire harness 10 and/or the band clip 60 from below. The first upward extending portion 52a and the second upward extending portion 53a of the support member 50 in the non-limiting embodiment shown in FIG. 3 may be configured to restrict a horizontal position shift of the wire harness 10 in cooperation with each other. For example, the first upward extending portion 52a and second upward extending portion 53a can be configured to restrict leftward and rightward position shifts, respectively, in FIG. 3, and are in some cases referred to as first and second side stopper plates, respectively, both of which may be flat plates. The same applies to the first upward extending portion 52a and the side wall portion 71 in the non-limiting embodiment shown in FIG. 4.
In the non-limiting embodiments shown in the figures, the support member 50 may be a one-piece item, for example, a metal one-piece item.

1. A wire fixing member that is configured to fix a wire harness laid out below an attachment object to the attachment object, the wire fixing member comprising:
a support having:
a plate-shaped support plate that is configured to extend along an extension direction of the wire harness and capable of supporting the wire harness from below; and
fixing portions provided at a plurality of locations along the extension direction on the support plate, extending upward from the support portion, plate, and capable of being fixed to the attachment object.

2. The wire fixing member according to claim 1, further comprising:
a holding-fixing member configured to hold a portion, in the extension direction, of the wire harness, the holding-fixing member being fixed to the support plate.

3. The wire fixing member according to claim 1, wherein:
the fixing portions include:
first fixing portion extending upward from a first end, in a width direction, of the support plate; and
a second fixing portion extending upward from a second end, in the width direction, of the support plate, and
the first fixing portion and the second fixing portion are provided alternately in the extension direction on the support plate.

4. The wire fixing member according to claim 1,
wherein the fixing portions are provided only at one end, in a width direction, of the support plate.

5. The wire fixing member according to claim 1,
wherein the support has a side wall extending upward from an end, in a width direction, of the support plate.

6. The wire fixing member according to claim 5, wherein:
the fixing portions are provided only at a first end, in the width direction, of the support plate, and
the side wall is provided only at a second end, in the width direction, of the support plate.
